(19) United States
(12) Patent Application Publication
(10) Pub. No.: US 2008/0240634 A1
(43) Pub. Date: Oct. 2, 2008

(54) SLIDING ELEMENT PROCEDURE AND DEVICE FOR ITS PRODUCTION

(76) Inventors: Kamran Laal Riahi, Marburg (DE); Armin Linker, Stadtallendorf (DE); Udo Roos, Homberg (DE)

Correspondence Address: Robert L. Stearns;Dickinson Wright PLLC, 38525 Woodward AV, Suite 2000, Bloomfield Hills, MI, 48304, US

(21) Appl. No.: 11/855,567

(22) Filed: Sep. 14, 2007

(30) Foreign Application Priority Data
Sep. 14, 2006 (DE) 10 2006 042 999.0
Sep. 14, 2006 (DE) 10 2006 043 065.4

(51) Int. Cl. C08J 5/16; F16C 33/20; B32B 5/00; B21D 53/10

(52) U.S. Cl. 384/300; 384/297; 264/171.1; 264/171.25; 29/898.055; 29/898.06; 29/724

(57) ABSTRACT

A method and a device is provided for producing a flat or arc-shaped sliding element with a very large radius of curvature. The sliding element has a sliding layer based on a fiber reinforced plastic with a plastic matrix and a reinforcing element containing at least one thread. The reinforcing element is deposited on a polygonal winding core by means of a guide with the addition of a synthetic resin forming the plastic matrix. The flat or arc-shaped segments formed between the edges are separated from the tubular, polygonal winding body thus formed after it has set.

### RELATED APPLICATIONS

This application claims priority to German Patent Application 10 2006 043 065.4-43, filed Sep. 14, 2006 and German Patent Application 10 2006 042 999.0-43, filed Sep. 14, 2006.

### BACKGROUND OF THE INVENTION

1. Technical Field

The invention relates to a sliding element, in particular a flat or bent sliding element with a very large radius of curvature, which has at least one sliding layer based on fiber-reinforced plastic with a plastic matrix and a reinforcing element containing at least one fiber or thread, a method and a device for its production.

2. Related Art

The use of composite fiber materials for sliding bearings, particularly on the basis of epoxy resins, is of prior art. Such sliding bearings consist, as is well known, of a single-layer sliding layer material or of a bearing material constructed from two layers, a support layer and a sliding layer. A support layer is typically characterised by a glass fiber or carbon fiber reinforced epoxy resin matrix which has a very high load absorption capacity. On this is laminated a sliding layer, which consists in most cases of special plastic fibers or threads of varying abrasiveness as reinforcing elements, solid lubricants and also of an epoxy resin matrix. The composition is set so that the required tribological properties are also set, which vary according to the material and condition of the counter-rotating element and the ambient conditions (wet or dry running).

The use of PTFE (polytetrafluoroethylene) or graphite, among other things, as a solid lubricant for the self-lubricating sliding layer, is of prior art. These substances are either added to the plastic matrix in particle form or, in the case of PTFE, are intertwined in the form of a filament with other plastic filaments to form the plastic thread of the sliding layer. As is well known, polyester is generally used as the thread plastic in most cases.

In order to produce flat sliding elements from such plastic threads or fibers they are first woven into fiber mats which are then laminated on to each other, having been impregnated with synthetic resin. This takes place, for example, in the injection mould process, where the mats are placed in a mould which is then filled under pressure with the synthetic resin. Another production method uses pre-impregnated reinforcing elements in the so-called prepreg method. These elements are present, for example, in the form of unidirectional threads, and also in the form of woven fiber mats or in any other forms of textile fabrics. The preimpregnated reinforcing elements (prepregs) must be cooled for storage. They are prefabricated for further processing according to the finished end product and are finally laminated on to each other in the pressing or autoclaving process.

Because of the many individual, in some cases manual operating steps, from the plastic thread to the finished sliding element, relatively long non-productive times are experienced. The production of such sliding elements is expensive.

The winding method is also known for the production of bearing bushes and radial sliding bearings, where first the sliding layer, then the support layer, is deposited onto a winding mandrel rotatably driven about its longitudinal axis in the form of either a thread or fiber impregnated with synthetic resin, with a particular winding structure, or in the form of a prefabricated textile fabric. The winding represents a simple, low cost production method for rotationally symmetrical sliding elements, but the winding method of prior art is not suitable for the production of flat sliding plates or bent sliding elements with a very large radius of curvature.

### SUMMARY OF THE INVENTION

The object of this invention is to provide a low cost, efficient method for producing such a sliding element, A further object is to provide a device by means of which such a method can be carried out. A final object is to provide a product produced in this manner, namely a low cost sliding element.

The method for producing the sliding element already described is characterised according to the invention in that the reinforcing element is deposited on a polygonal winding core with the addition of a synthetic resin forming the plastic matrix, and in that the tubular, polygonal winding body thus formed is broken down into the segments formed between the edges after setting.

The device according to the invention for producing a sliding element therefore has a winding core rotatably driven about its longitudinal axis and a feed for the reinforcing element, which is characterised in that the winding core is polygonal.

The reinforcing may therefore be deposited on the winding core rotating about its longitudinal axis in the form of a prefabricated textile material. A multiplicity of textile materials, such as woven fabrics, machine knitted and knitted fabrics or wicker work may be considered here as reinforcing elements.

However, the reinforcing element may also be placed around the polygonal winding core in the form of individual or a plurality of bundled threads.

The feed for this is preferably driven so that it moves back and forth relative to the winding core along its longitudinal axis. Furthermore, the device has a control system for driving the rotary and back and forth movement, which system is set up to deposit the reinforcing element with a certain winding structure on the winding core.

A sliding element produced by means of such a device according to the invention is characterised in that the reinforcing element has a winding structure which has been produced by winding the reinforcing element, preferably in the form of one or a plurality of parallel threads, onto a polygonal winding core in the region of the flat or arc-shaped segments formed between the edges.

Such a winding structure differs from the textile material structures by more individual adaptability to the requirements. For the winding, and hence the winding structures, have the advantage that they can be arranged specifically in the fiber composite according to the stresses, i.e. taking into consideration the distribution of forces and stresses, by setting the course of the fibers or threads by suitable programming of the control system. The fibers or threads are therefore wound to cover the entire surface, in an alternating fashion, at a certain deposit angle. Variable wall thicknesses may also be produced in this manner.

Moreover, the waviness of the individual winding layers is reduced compared to fabric layers, which positively influences the tribological property of the winding layer compared to that of a fabric.

Producing flat or almost flat layers in the winding technique is only possible according to the invention, however, by the use of a polygonal winding core. For this purpose the winding core preferably has flat or arc-shaped segments or wall sections between the edges. Unlike in the production of sliding elements with a circular cross-section, winding body segments that also have a straight or arc-shaped cross-section are therefore formed between the edges, which segments, after setting of the winding body, are cut out from it and can be further processed into the finished sliding elements.

In a particularly preferred embodiment of the sliding element the thread is a plastic thread of polyester filaments into which are worked, and in particular spun, PTFE particles.

Such a thread has a multiplicity of advantages over the twisted fibers of prior art consisting of two polyester filaments and one PTFE filament. Firstly there is greater variability in the content of the individual components of the thread/fiber, particularly the PTFE content. Therefore its properties can be modified much more precisely even during the production of the plastic thread. Due to the fact that the PTFE particles do not adhere together, unlike the PTFE filament, i.e. due to the PTFE particles arranged and anchored randomly inside the polyester filaments, the plastic thread has a roughed up appearance and a better adhesive bond is achieved between the plastic thread and the plastic matrix. Finally, the binding of the PTFE particles in the plastic thread reinforces the mechanical retention of the same, due mainly to positive mechanical engagement.

As a result improved mechanical machinability of the sliding layer is therefore achieved without impairing the tribological properties or wear resistance.

In the method according to the invention the winding body segments are therefore re-machined, preferably with cutting, after being removed.

The use of the plastic thread with PTFE particles in the sliding layer is to this extent especially suitable for precision sliding elements which have to be re-machined to the final dimension by grinding or cutting, for example, after winding and setting, as well as segmenting. The use of the plastic thread with PTFE particles also opens up other fields of application in which lubrication or dirt grooves, for example, have to be worked into the sliding layer, by means of which particles or lubricants can be specifically removed or fed.

In a preferred further development of the method PTFE particles are also added to the synthetic resin.

If the sliding element has a support layer based on a fiber reinforced plastic with a plastic matrix and a fiber or thread as a reinforcing element, either first the fiber or thread of the support layer plastic, then the fiber or thread of the sliding layer plastic is advantageously deposited onto the winding core with the addition of a synthetic resin forming the plastic matrix, with a particular winding structure, or conversely first the fiber or thread of the sliding layer plastic, then the fiber or thread of the support layer plastic.

Both layers may be produced in this manner in the winding method on the same winding device, at low cost. The efficiency of the production method is particularly increased when the plastic matrix of the sliding layer plastic and of the support layer plastic consist of the same synthetic resin, preferably epoxy resin. Just as for the plastic matrix of the sliding layer, epoxy resin is also suitable as a plastic matrix for the support layer due to excellent adhesion properties, mechanical and dynamic properties. Because of its molecular structure epoxy resin also has very good moisture resistance and comparatively little tendency to swell. Because the same plastic matrix is used in both the sliding and support layers, the binding forces between the sliding and support layers are also increased.

In the method according to the invention it is advantageous for the winding core to be rotated about its longitudinal axis when the fiber or thread of the sliding and/or support layer plastic is deposited on the core, and for the fiber or thread to be guided along the longitudinal axis of the winding core in a back and forth movement.

In another preferred embodiment a plurality of fibers or threads are simultaneously deposited on the winding core. In this case it is advantageous for the plurality of fibers to be braided together when being deposited. Highly complex structures can also be produced in this manner.

The winding core of the device according to the invention is preferably formed by a polygonal mandrel.

This mandrel may be designed in the form of a folding core for easier removal of the winding body from the mould during setting of the synthetic resin, the body being shrunk on to a certain extent in most cases. If the mandrel is designed fixed (in one piece), it is preferably of a conical design for easier removal of the set winding body from the mould.

In a preferred further development, the device according to the invention is characterised by a pulling device which is set up to pull off the tubular, polygonal winding core deposited onto the winding core after the synthetic resin is set.

In another embodiment the winding core has at least two essentially parallel rods mounted rotatably about a common central axis.

In such a device the threads or fibers are wound around the at least two rods so that flat surfaces are formed between the rods. Since the synthetic resin is initially still liquid during winding, the rods are suitably wound with a film which creates a defined surface for the inner layer of the reinforcing element lying on it. In this embodiment conicity or a pulling off device may be dispensed with. For when the rods are brought together radially during removal from the mould, the winding body is free for removal.

The device preferably has an impregnating device filled with synthetic matrix, forming the plastic matrix, which impregnating device is arranged so that the thread is guided through before being deposited on the winding core. Alternatively the fibers or threads may also be impregnated with the matrix resin by the RTM or RIM method.

According to an advantageous further development the device has a cutting station which is set up to separate the segments formed between the edges when the winding body is set.

### THE DRAWINGS

Further objects, characteristics and advantages of the invention are explained in the following with reference to an exemplary embodiment with the aid of the drawings, in which:

FIG. 1 shows a perspective representation of the winding device, with a square mandrel, according to the invention;

FIG. 2 shows an exemplary embodiment of a winding core of the device according to the invention, comprising two rods;

FIG. 3 shows an exemplary embodiment of a winding core consisting of a triangular mandrel;

FIG. 4 shows a finish set pentagonal winding body;

FIG. 5 shows a three-dimensional view of an exemplary embodiment of the winding device according to the invention, with braiding head;

FIG. 6 shows a three-dimensional view of an exemplary embodiment of the winding device according to the invention for winding prefabricated textile fabrics, and

FIG. 7 shows a sectional representation through a further exemplary embodiment of a winding core with bent segments.

### DETAILED DESCRIPTION

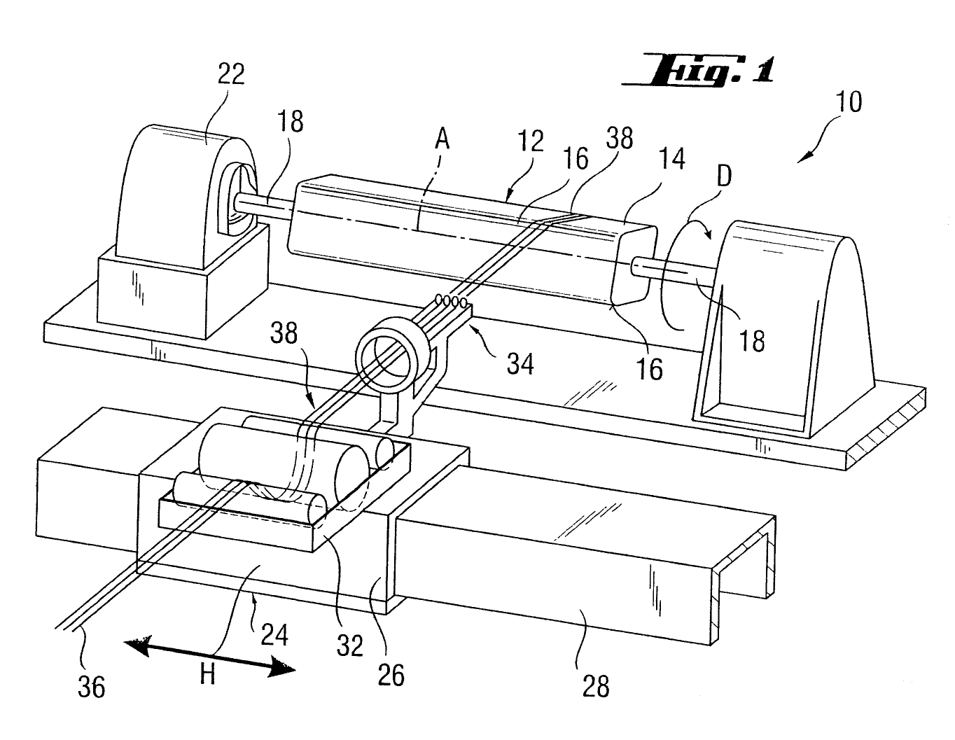

The exemplary embodiment of winding device 10 according to the invention, shown in FIG. 1, has a winding core 12 mounted rotatably about its longitudinal axis A, in the form of a square tube or mandrel 14, with rounded edges 16. Rounded edges 16 reduce the mechanical loading of the thread during winding and hence the risk that it might tear. Square tube 14 is mounted rotatably on both sides by means of a shaft 18 and is rotarily displaced by a drive 22.

Winding device 10 also has a guide 24 that can be moved back and forth along longitudinal axis A. This guide is formed by a carriage 26, which is moved back and forth by means of linear drive on a rail 28, which is aligned parallel with longitudinal axis A. Carriage 26 has an impregnating tank 32 filled with synthetic resin and guiding elements 34 for feeding a thread bundle 38 consisting of a plurality of threads 36.

Because of rotary movement D of winding core 12 on the one hand and back and forth movement H of guide 24 coupled to it on the other, a certain pre-programmed winding structure can be produced. A control system, not shown, for drive 22 of winding core 12 and the linear drive of guide 24, coordinates the movements taking into consideration the cross-sectional shape of winding core 12 so that the desired winding structure is produced.

In order to be able to detach the winding body from such a winding core 12, the winding core is tapered slightly towards one end. However, this is not shown in FIG. 1.

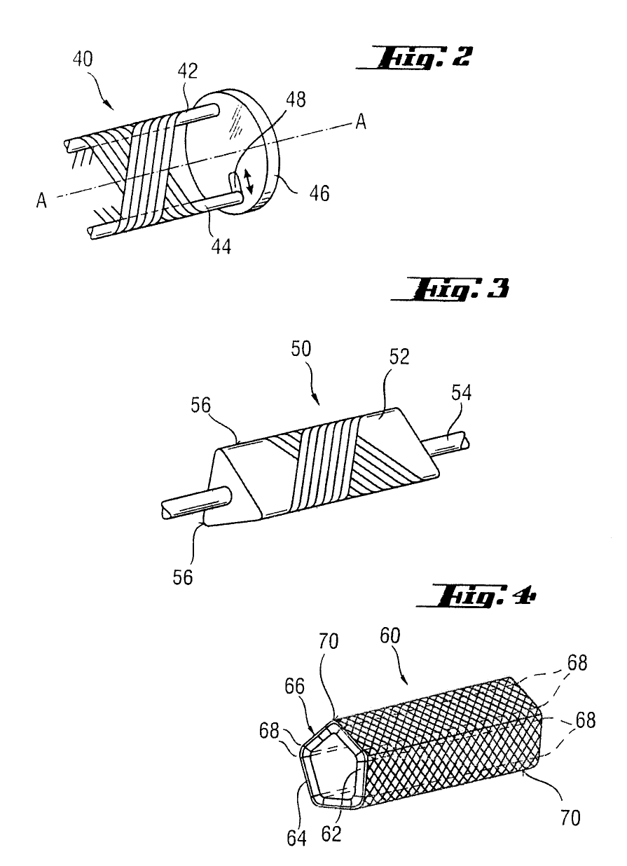

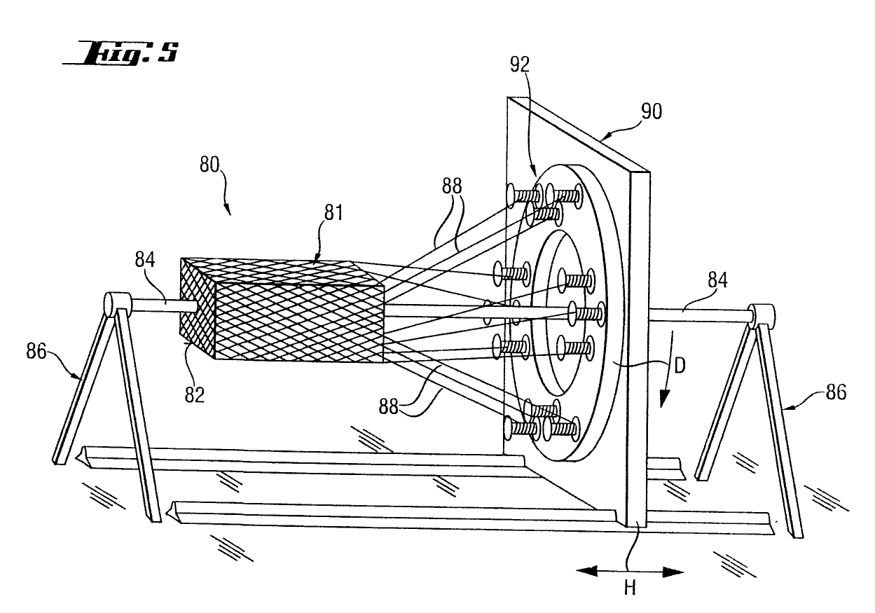

FIGS. 2 and 3 show two alternative embodiments of the winding core, in section. Winding core 40 according to FIG. 2 has two opposing rods 42 and 44 at the same distance from longitudinal axis A, with a round cross-section, which rods are fixed to both ends by means of a disc 46, only one disc 46 being shown here for the sake of simplification. While first rod 42 is located at an invariable distance from the longitudinal and central axis A, second rod 44 can be moved radially back and forth along a guide path 48. The distance between the rods can in this way be reduced to release the winding body for removal from the mould.

A winding body, in the form of a hollow flat profile, is produced around the two rods 42, 44. Within the meaning of the invention the term polygonal winding core may therefore also be understood to mean cores which in cross-section define at least two deflection points around which the winding body is wound. Just as for the rounded edges 16 of square mandrel 14 according to FIG. 1, the round cross-section of rods 42, 44 reduces the risk of damaging the threads during winding.

Winding core 50 according to FIG. 3 is formed from a tube or mandrel 52 with a triangular cross-section, which is in turn supported on both sides by means of a shaft 54. Here too longitudinal edges 56 are rounded so that the fibers or threads are not damaged during winding.

FIG. 4 shows a winding body 60 which has been wound onto a pentagonal winding core and pulled off from it after setting. On its inside there is a slightly thicker support layer 62, which has first been deposited on a winding core. The slightly thinner sliding layer 53 ha then been deposited on its outside before setting.

For producing flat sliding elements the five flat winding body segments 66 formed between the edges are separated along the marked parting lines 68 on the basis of winding body 60 shown in FIG. 4. Parting lines 68 preferably lie as close as possible to the rounded edges 70 to minimise cutting. The separation is carried out in a cutting station, preferably by means of a saw, a knife or a cutting-off wheel.

Because of the different shrinkage properties of the wound materials, there is a risk that the flat segments will have a slight curvature after setting. It may therefore be necessary, particularly for the production of high precision sliding elements, for the segments separated by the method described above to be re-machined mechanically or with cutting until they have the required flatness. For this purpose they may be milled or ground, for example, for which sliding element plastics with threads or fibers as reinforcing elements, consisting of polyester filaments into which are spun PTFE particles, are eminently suitable.

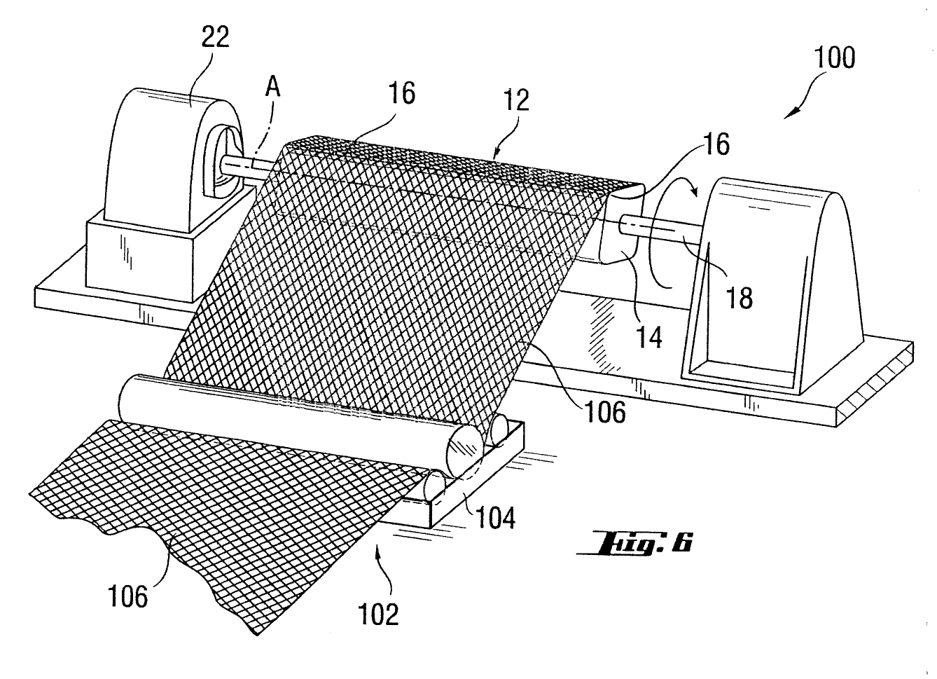

FIG. 5 shows another embodiment of winding device 80 according to the invention. This device has a winding core 81 in the form of a quadratic square tube or mandrel 82, which is rigidly suspended on a frame 86 on both sides by means of a shaft 84. A plurality of fibers or threads 88 are simultaneously deposited on mandrel 82. This is achieved by means of guide 90, which can be moved back and forth along the longitudinal axis of winding core 81, as illustrated by arrow H, which guide has a braiding head 92 which is rotatably mounted about the longitudinal axis according to arrow D. In the case of this device winding core 81 can therefore be rigidly arranged—all that is important here is the relative movement between winding core 80 and braiding head 92. Because of the superposition of rotary movement D of braiding head 92 and the linear back and forth movement D of guide 90, a winding structure, in this case a fabric-like winding structure, is produced. Because of the fibers or threads 88 crossed several times, very complicated fiber orientations deviating from the geodetic line may be achieved, so that the fibers or threads 88 can also be deposited on highly complex winding bodies.

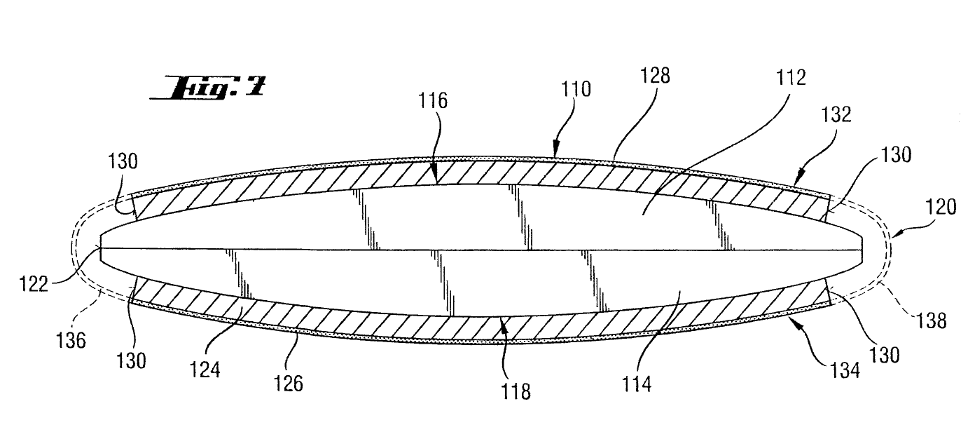

FIG. 6 shows a further embodiment of winding device 100 according to the invention. This device has the same winding core 12 rotatably mounted about its longitudinal axis A in the form of a square mandrel 14 with rounded edges 16, as shown in FIG. 1. Square tube 14 is also rotatably supported on both sides by means of a shaft 18, and is displaced rotarily by a drive 22.

However, winding device 100, unlike that shown in FIG. 1, has a fixed guide 102 with an impregnating tank 104 for feeding a wide, prefabricated textile fabric 106. The width of the guide and the fabric is adapted to the width of winding mandrel 14, so that one complete layer of the reinforcing element is deposited on winding mandrel 14 with each revolution of the winding core.

FIG. 7 shows an exemplary embodiment of a winding core 110 according to the invention in cross-section, which core consists of two flat half-moulds 112 and 114 which each have on their opposing side facing outwards a large radius of curvature, i.e. an arc-shaped segment 116 and 118 respectively of a cylindrical surface area. The winding core thus formed has edges 120 and 122 on both sides in the region of the outlet of the segments, i.e. in the region of the interface of the flat half-moulds 112, 114.

First a support layer 124, then a sliding layer 126 with a lenticular cross-section, are deposited on winding body 110 by means of one of the winding methods described above. Two arc-shaped winding body segments 132, 134, which can then be further processed into the arc-shaped sliding elements, are separated from winding body 128 thus formed, with the lenticular cross-section, along parting lines 130, after the plastic matrix is set. Sections 136, 138 represented by dotted lines are waste material. Sliding elements can be produced in this manner for radial sliding bearings with a much larger diameter than the dimensions of a mandrel with a round cross-section permit.

The invention is obviously not limited to the exemplary embodiments shown. The winding core of the winding device according to the invention may in principle have any polygonal cross-section. Furthermore, single or multi-layer sliding element can be produced within the scope of the invention, neither the reinforcing elements nor the plastic matrix being limited to the choice of materials mentioned.

1. A method for producing a sliding element which has at least one sliding layer comprising a fiber reinforced plastic having a plastic matrix and a reinforcing element containing at least one fiber or thread, wherein the reinforcing element is deposited on a polygonal winding core with the addition of a synthetic resin forming the plastic matrix, and in that segments of a tubular, polygonal winding body are formed between edges of the body which are separated from the tubular, polygonal winding body after setting of the body.

2. The method according to claim 1, wherein the thread is a plastic thread of polyester filaments into which are spun PTFE particles.

3. The method according to claim 1, wherein the separated segments are re-machined with cutting.

4. The method according to claim 1, wherein PTFE particles are added to the synthetic resin.

5. The method according to claim 1, wherein the sliding element has a support layer based on a fiber reinforced plastic with a plastic matrix and a reinforcing element containing at least one fiber or thread, wherein first the reinforcing element of the support layer plastic, then the reinforcing element of the sliding layer plastic is deposited on the winding core with the addition of a synthetic resin forming the plastic matrix.

6. The method according to claim 1, wherein the sliding element has a support layer based on a fiber reinforced plastic with a plastic matrix and a reinforcing element containing at least one fiber or thread, wherein first the reinforcing element of the sliding layer plastic, then the reinforcing element of the support layer plastic is deposited on the winding core with the addition of a synthetic resin forming the plastic matrix.

7. The method according to claim 1, wherein the reinforcing element of the support layer plastic is formed from a glass fiber.

8. The method according to claim 1, wherein during the depositing of at least one thread of the sliding and/or support layer plastic, the winding core is rotated about its longitudinal axis A and the thread is guided along the longitudinal axis of the winding core in a back and forth movement.

9. The method according to claim 1, wherein a plurality of threads in a thread bundle are deposited on the winding core.

10. The method according to claim 8, wherein a plurality of threads are simultaneously intertwined with each other during depositing.

11. The method according to claim 1, wherein the reinforcing element of the sliding and/or support layer plastic in the form of a prefabricated textile fabric is deposited on the winding core rotating about its longitudinal axis A.

12. A sliding element with at least one sliding layer comprising a fiber reinforced plastic with a plastic matrix and a reinforcing element containing at least one thread, wherein the reinforcing element has a winding structure which has been produced by winding the at least one thread on a polygonal winding core in the region of segments formed between edges of the winding structure.

13. The sliding element according to claim 12, wherein the thread is a plastic thread of polyester filaments into which are spun, PTFE particles.

14. A device for producing a sliding element which has at least one sliding layer comprising a fiber reinforced plastic with a plastic matrix and a reinforcing element containing at least one fiber or thread, with a winding core driven so that it can be rotated about its longitudinal axis, and a guide for the reinforcing element, wherein the winding core is polygonal.

15. The device according to claim 14, wherein the guide is driven so that can be moved back and forth relative to the winding core along its longitudinal axis, where a control system is provided for the drive of the rotary and back and forth movement, which system is set up to deposit the reinforcing element with a certain winding structure on the winding core.

16. The device according to claim 14, wherein the winding core has a polygonal mandrel.

17. The device according to claim 16, wherein the mandrel is conical.

18. The device according to claim 15, wherein the winding core has at least two essentially parallel rods mounted so that they can be rotated about a common central axis.

19. The device according to claim 14, including an impregnating device filled with a synthetic resin forming the plastic matrix, which device is arranged so that the reinforcing element is guided there through before being deposited on the winding core.

20. The device according to claim 19, including a pulling device set up to pull off a tubular, polygonal winding body deposited on the winding core after it has set.

21. The device according to claim 20, including a cutting station set up to separate the segments formed between edges after the winding body has set.

22. The device according to claim 14, wherein the guide includes a braiding head set up for the simultaneous feeding and intertwining of several fibers or threads.

23. The device according to claim 14, wherein the winding core has flat segments between the edges.

24. The device according to claim 23, wherein the winding core has arc-shaped segments between the edges.
